(19) United States
(12) Patent Application Publication
(10) Pub. No.: US 2005/0200810 A1
(43) Pub. Date: Sep. 15, 2005

(54) Motion picture playback system providing two or more language soundtracks simultaneously

(76) Inventor: Steven A. Morales, Stockton, CA (US)

Correspondence Address: CAHILL, von HELLENS & GLAZER P.L.C., 155 Park One, 2141 East Highland Avenue, Phoenix, AZ, 85016, US

(21) Appl. No.: 10/439,348

(22) Filed: May 15, 2003

Related U.S. Application Data
(60) Provisional application No. 60/381,031, filed on May 15, 2002.

(51) Int. Cl. G03B 31/00

(52) U.S. Cl. 352/12

(57) ABSTRACT

A movie projection system includes a film projector for projecting moving images of a film while broadcasting the film sound track in two or more languages simultaneously to different film viewers who view the film at the same theater. A time code reader detects time code signals recorded on the film and derives sync signals therefrom. A playback system receives the sync signals for generating first and second sound tracks, in first and second languages, respectively, each synchronized with the images recorded on the film. The first sound track is broadcast over the usual theater sound system, while the second sound track is transmitted to receivers worn by those viewers who speak the second language.

### CROSS REFERENCE TO RELATED APPLICATIONS

The present application related to subject matter described in and claims priority to a provisional application entitled “SIMULTANEOUS MULTI-LANGUAGE MOTION PICTURE PLAYBACK SYSTEM,” assigned Ser. No. 60-381,031 and assigned a filing date of May 15, 2002, and describing an invention made by the present inventor.

The present application also relates to a pending application Ser. No. ______, filed concurrently herewith, entitled “SIMULTANEOUS MULTI-LANGUAGE MOTION PICTURE PLAYBACK SYSTEM”, filed by the present applicant, describing and claiming similar subject matter.

### BACKGROUND OF THE INVENTION

1. Field of the Invention

The present invention relates generally to audio systems for motion picture theaters, and more particularly, to an audio system for a movie projector that allows for playback of the audio track in more than one language.

2. Description of the Related Art

The United States is clearly becoming a nation of many languages. Unfortunately, if a person in the United States is not fluent in the English-language, such person can not always enjoy some of the same activities as English-speaking people—especially when it comes to movies and related forms of entertainment.

Over the years, movies and sound have come almost full circle. Initially, pianist, organist, and even live orchestras accompanied films to enhance the viewing experience. In 1926, Warner Brothers produced a film called “Don Juan” with only music as the sound track. The “Jazz Singer”, introduced in 1927, was the first movie to include both voice and music within the sound track, and used a wax record and a Vitaphone. The earliest of “talking pictures” used a film projector and a record player. Once the film started, an operator standing nearby the film projector and record player would start the record player and try, as best as possible, to keep the two in sync. As technology improved over the years, a sound track was optically placed on the video film track, and the external sound machine (i.e., record player) was no longer needed. Sound for movies was activated by a light passing over the sound track on the film and sent through amplifiers and speakers for reproduction in the movie theater.

The movie industry has constantly sought better sound, and over the years, shifted from monaural sound to stereo sound; however, the stereo sound track was still optically recorded onto, and recovered from, the video film. Later, external “playback devices”, or sound machines, were combined with movie projectors to make use of more advanced, and better quality sound, on recorded on CDs and the like. These “playback devices” were synced with “time codes” on the film. External “playback devices”, such as those available from Digital Theatre Systems of Agoura Hills, Calif., play two CDs with the sound for movies; if the movie is short, only one CD is required. This machine, quite often, is made with a third CD drive in order to sync the upcoming movie preview sound. The use of CDs allows for much better quality sound, and almost perfect syncing between film and sound, even though the sound is once again generated on an external device.

Today, theaters use either external playback devices or sound recorded upon the actual film in order to generate the sound track to be broadcast in the movie theater. Currently, most movie theaters show films by using 1) a film projection unit; 2) a sound reader; and 3) a time code reader for an external playback machine. Some sound movie houses do not use an external playback machine, but rely solely on the sound recorded on the film, as read by the aforementioned sound reader. Film is fed into the projection unit. As the film runs, the sound reader attached to the film projection unit reads the sound track from the film. The time code reader can be attached to the film projection unit to activate the external playback device; the time code reader reads dots and dashes that are placed on the film in order to sync the images on the film with the sounds being derived from the external playback machine. Alternatively, the sound track can be created with external playback devices via a time code reader used to activate such external playback devices. However, current technology only allows for sound to come from the film itself, or from an external playback device, and not from both sources at one time; moreover, the sound track recorded on the film is in the same language as the sound track generated by the external playback device. While film producers continue to embed sound tracks on the film itself, new, higher quality “playback devices” are now used to provide a greatly enhanced listening experience. Typically, the external playback device is the primary source for sound, while the sound track embedded on the film itself is used as a back-up source, if needed. Currently, the sound track embedded on the film itself can accommodate only one language in sync with the external “playback device.”

While movies have made tremendous strides in the quality of sound that can be reproduced within a movie theater, movies continue to only accommodate one language per film, and in the United States, that language is typically English. However, many people living in the United States do not speak English well. The United States Census for the year 2000 reported that there were approximately 35 million Hispanics in the U.S. Many of these people do not have a great command of the English language. Indeed, it is not unusual among Spanish-speaking families who attend movie theaters for one of the children to translate words for the other family members present.

Because of existing technology and current film systems, theaters either show a movie in English, use foreign sub-titles, or decide to show a foreign language film in another language for the entire audience. Sub-titles are difficult to use and distract from the viewing experience. On the other hand, dedicating a total theater auditorium for a foreign-language film can be costly. Years ago, there were many Spanish Cinemas throughout California that played foreign films in Spanish, or late-release American films with sub-titles. Sub-titles can be troubling for most people to use while watching a film, and with Spanish films on videotape becoming more and more popular, the aforementioned Spanish cinemas have faded away.

Until now, movie theaters have not broadcast movie film sound tracks in multiple languages at the same time within a movie theater. With the world becoming more and more multi-lingual, there is a tremendous need for a movie film system compatible with existing movie technology, but which permits members of the same viewing audience to hear more than one language. For years, Spanish-speaking families in the United States had to wait months in order to enjoy a new release movie in Spanish when the video or DVD came out with Spanish-language dubbing. Ironically, many of these new-release movies were being released in Mexico, Central and South America and Spain, in Spanish, and at virtually the same time that such movies were being released in the United States in English.

For example, the movie Harry Potter was first released in English in December 2001, but Spanish-speaking families in the U.S. were not able to be able to enjoy it until May 28, 2002 when the DVD with Spanish option was scheduled for introduction. Interestingly, in regard to most new release movies, the Spanish dubbed version is ready for shipment at the same time that the English versions are first shipped to theaters in the United States.

There are in use today systems for use by those who are hearing-impaired, including systems for amplifying the sound that is being broadcast over the theater's speaker system. Such systems for the hearing-impaired are generally attached to the aforementioned playback machine and broadcast the sound track in the same one language that is being performed by the sound system of the theater. These systems for the hearing-impaired are generally “closed” systems that require a set transmitter and a receiver that only work with each other. Again, these systems for the hearing-impaired have not been used in movie theaters to transmit a sound track in a language different from that simultaneously being broadcast over the speaker system of such movie theater.

Accordingly, it is an object of the present invention that allows theater-goers who do not speak English well to attend movie theaters showing English-language films and still enjoy the movie.

Another object of the present invention is to allow a number of different theater-goers within the same movie theater to simultaneously view the same movie images while hearing the movie sound track simultaneously in different languages.

Still another object of the present invention is to provide such a movie theater system that can be constructed as a combination of well-known, currently-available components at relatively little cost.

These and other objects of the present invention will become more apparent to those skilled in the art as the description thereof proceeds.

### SUMMARY OF THE INVENTION

Briefly described, and in accordance with a preferred embodiment thereof, the present invention relates to a movie projection system for projecting moving images of a film and for broadcasting a film sound track in at least two different languages simultaneously to film viewers located in the same viewing location, e.g., a movie theater. The movie projection system includes a film projection unit for projecting images recorded on the film, as well as a time code reader coupled to the film projection unit for detecting time code signals recorded on the film. The time code reader derives sync signals from the time code signals. These sync signals are provided to a playback system capable of simultaneously generating two or more different sound tracks in two or more different languages. The playback system may be a single integrated device, or it may include distinct first and second playback machines. The playback system and/or distinct playback machines may be of the type used to play compact discs on which the sound track of the film has been recorded in different languages; alternatively, the playback system and/or distinct playback machines may be of the type used to store and retrieve digital sound files that represent the sound track for the film in two or more different languages.

In the instance wherein two or more separate playback machines are used, the first playback machine generates a first sound track in a first language synchronized with the images recorded on the film, and the second playback machine generates a second sound track in a second, different, language that is likewise synchronized with the images recorded on the film. The second playback machine may be coupled directly to the time code reader for directly receiving the sync signals; alternatively, the second playback machine may be coupled to the time code reader via the first playback machine for receiving such sync signals.

A first transmission system is coupled to the playback system for transmitting the first sound track to at least a first film viewer who desires to hear the first sound track. This first transmission system may, for example, include a conventional DTS decoder, amplifier and theater speaker system used to broadcast an English-language sound track within the theater. A second transmission system is coupled to the playback system for transmitting the second sound track to a second set of film viewers who desire to hear the second sound track in the second language, for example, in Spanish. This second transmission system might include a wireless transmitter for transmitting a high frequency (e.g. radio frequency or optical) signal within the theater. This high frequency signal has a frequency that is above the range audible to humans and containing the second sound track embedded therein, as by amplitude modulation (AM) or frequency modulation (FM), for example. A wireless receiver is disposed proximate each of the second set of film viewers for receiving the high frequency signal. Each such wireless receiver derives the second sound track therefrom, and plays the second sound track audibly to each of the second set of film viewers, as within headphones worn by such viewers.

Alternatively, the second transmission system may incorporate a hard wired connection network coupled between the playback system and a headphone jack provided at each theater seat. Those film viewers wishing to listen to the second sound track simply plug in headphones to such headphone jacks to hear the second sound track in the second language. Where two or more different language sound tracks are made available to the headphone jacks at each viewer's seat, a channel selector is also provided at the viewer's seat for allowing the viewer to select from among the various sound tracks made available.

The present invention also relates to an improved method of projecting moving images of a film while broadcasting a film sound track in at least two different languages simultaneously. The present method includes the steps of projecting images recorded on the film for simultaneous viewing by at least first and second film viewers located at the same location, such as a movie theater, while detecting the time code signals recorded on the film to derive sync signals therefrom. The method further includes the steps of generating a first sound track in a first language synchronized with the images recorded on the film, and generating a second sound track in a second language likewise synchronized with the images recorded on the film, and wherein the second language differs from the first language. In addition, the present method includes the steps of transmitting the first sound track to the first film viewer, and transmitting the second sound track to the second film viewer. Preferably, the first and second sound tracks are generated by playing first and second compact discs recorded in the first and second languages, respectively, or by retrieving first and second stored digital sound files from an electronic storage device. In the preferred form of the invention, the first sound track is transmitted to the first film viewer by amplifying the first sound track and driving audio speakers installed at the viewing location with the amplified first sound track. The second sound track can be conveyed to the second film viewer by using a wireless transmitter and receiver, or by hard wiring the second sound track over a hard wired connection to a signal port provided at each viewer's theater seat. In either case, the second film viewer wears headphones to hear the second sound track in the second language.

### BRIEF DESCRIPTION OF THE DRAWINGS

FIG. 1 is a block diagram showing a first embodiment of the present invention wherein the second playback machine used to generate the second (foreign language) sound track receives sync signals indirectly via the first playback machine.

FIG. 2 is a block diagram showing a first embodiment of the present invention wherein the first and second playback machines are both directly coupled to the time code reader for directly receiving the sync signals in parallel.

### DETAILED DESCRIPTION OF THE PREFERRED EMBODIMENTS

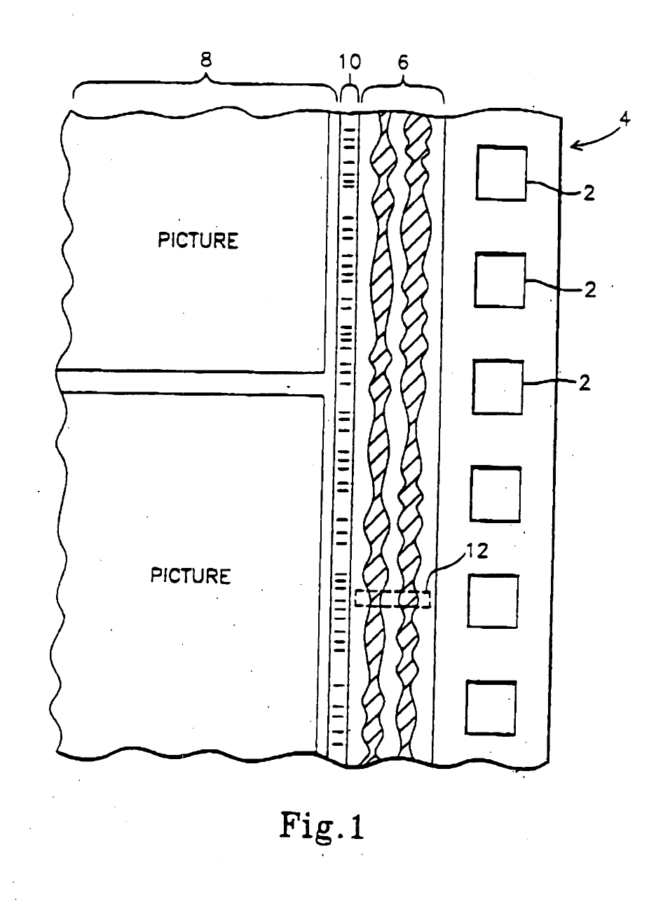

Referring to FIG. 1, a movie projection system constructed in accordance with a first preferred embodiment of the present invention is identified generally by reference numeral 20 and includes, film projection unit 22 for projecting moving images recorded on a movie film (not shown) onto a display screen, for example, a movie theater film screen. Film projection unit 22 may be, for example, a Simplex 35 Projector commercially available from Strong International/Strong Cinema Products, a division of Ballantyne of Omaha, Inc. of Omaha, Nebr.

As is known to those skilled in the art, the film has recorded thereon both images and time code signals for syncing a film sound track. A special DTS® time code is printed on the motion picture print along with a conventional stereo analog optical soundtrack. The time code is used by the DTS® system to synchronize the sound and picture. The time code physically lies between the picture frames and the optical sound track near one edge of the film, and is printed onto the release print from the soundtrack negative. A time code reader 24 is coupled to film projection unit 22 for detecting the time code signals recorded on the film and deriving the sync signals therefrom. Time code reader 24 may be a DTS® brand reader head of the type commercially available from the DTS Cinema Division of Digital Theater Systems, Inc. of Agoura Hill, Calif. Time code reader 24 is mounted just above or just below the lens of projection unit 22 and can be secured to projection unit 22 by special mounting brackets also available from DTS Cinema Division.

Time code reader 24 reads time code signals on the movie film to synchronize playback of sound tracks from CD-ROM discs or digital sound track files, thereby ensuring that the correct sound is played for each frame of film projected. The derived sync signals are provided to a 9-pin time code electrical cable 26 and are received by a first playback machine 28. First playback machine 28 might be, for example, a Model DTS-6D Digital Playback System commercially available from the DTS Cinema Division of Digital Theater Systems, Inc. of Agoura Hill, Calif., which incidentally includes its own DTS time code reader. The basic operation of such digital playback machines is described in U.S. Pat. No. 5,386,255 to Beard, et al., the disclosure of which is hereby incorporated by reference.

First playback machine 28 receives one or more compact discs and, in conjunction with the sync signals, generates a first sound track in a first language (e.g., English) synchronized with the images recorded on the film. The projectionist inserts the movie sound track CD disc(s) into the DTS-6D playback machine and threads the film though the DTS time code reader head. Once the film is started, the DTS system checks a keyed serial number in the time code and on the movie disc(s) to assure the correct sound is being played with the movie being shown. Films released in the DTS digital sound format also contain a traditional analog (optical) sound track which serves as a back-up sound source. The first sound track generated by first playback machine 28 is provided over signal line 30 to a sound processor 32, for example, a DTS signal processor like the Model DTS-6AD Cinema Processor the DTS Cinema Division of Digital Theater Systems, Inc. of Agoura Hill, Calif., or the Model No. CP65 Dolby cinema processor commercially available from Dolby Laboratories, Inc. of San Francisco, Calif.

While not essential to the practice of the present invention, film projection unit 22 might also be coupled to audio reader 34 for reading the audio track recorded on the movie film itself. Audio reader 34 may be, for example, either a Simplex 5 Star 35 mm Optical Soundhead commercially available from Strong International/Strong Cinema Products, a division of Ballantyne of Omaha, Inc. of Omaha, Nebr., or a Dolby® Digital Reader, such as the Dolby® Cat. No. 701 Digital Soundhead from Dolby Laboratories, Inc. of San Francisco, Calif. Some film projectors actually incorporate built-in audio readers. Add-on audio readers mount directly to projection unit 22. In either case, audio reader 34 scans a portion of the film as it passes through projection unit 22, and light from an LED (light emitting diode) shines through the sound track portion of the film onto a CCD (charge coupled device) to detect the audio signals recorded on the film.

As mentioned above, the output of audio reader 34 may be used as a back-up source of the audio track in the event that first playback machine 28 is not operating properly. The output of audio reader 34 is coupled by signal line 36 to another input of sound processor 32. Sound processor 32 can use either the coded output of first playback machine 28, or the output of audio reader 34, as the source of the first sound track. The output of processor 32, which may be a stereo or multi-channel output signal, is coupled to amplifier unit 38 which amplifies the first sound track and provides it to the theater speakers 40 for broadcast audibly to film viewers desiring to hear the sound track in the first language (i.e., English). Processor 32, amplifier 38 and speakers 40 may collectively be regarded as a first transmission system for transmitting the first sound track to the first group of film viewers who want to listen to the sound track in the first language.

Still referring to FIG. 1, a second playback machine 42 is coupled indirectly to time code reader 24 via first playback machine 28 and cable 44. The DTS Model DTS-6D digital playback machine described above in conjunction with first playback machine 28 includes an output port that provides a copy of the time code signals received at the time code input port thereof, thereby allowing two or more of such playback machines to be “daisy-chained” together. Second playback machine 42, which is preferably of the same model and manufacture as described above for first playback machine 28, receives one or more compact discs that have recorded thereon a sound track in the second language. Second playback machine 42 receives the sync signals via conductor 44 and is responsive thereto for generating a second sound track in a second language (e.g., Spanish) synchronized with the images recorded on the film. While playback machines 28 and 42 have been described as playing CDs, those skilled in the art will appreciate that such playback machines may instead use digital sound files stored in an electronic memory device, such as a computer hard drive or the like.

The output of second playback machine 42 is coupled by cable 46 to transmitter 48; as shown in FIG. 1, transmitter 48 may include an antenna 50 for serving as a wireless transmitter. For example, transmitter 48 may be a high fidelity FM transmitter for transmitting within the commercial FM broadcast band (88.1-107.5 MHZ), of the type commercially available from Decade Transmitters, Inc. of Sherbrooke, Canada under Model No. MS-100S; such transmitter is provided with a suitable adjustable antenna for use with such transmitter to enhance delivery of the transmitted signal, and is adapted to transmit FM radio signals over short ranges inside public buildings. While the Model MS-100S is designed to transmit only monaural signals, a suitable FM stereo transmitter could also be used. Transmitter 48 and antenna 50 transmit a high frequency signal, i.e., above the frequency range that is audible to humans, and preferably within a radio communication frequency band or an optical band of electromagnetic radiation. This high frequency signal contains, in coded or modulated form, the second sound track, and is broadcast throughout the theater.

A film viewer desiring to hear the second sound track receives such high frequency signal by using receiver 52 equipped with antenna 54. Receiver 52 may be a conventional AM/FM receiver, for example, such as the Sony Walkman Model SRF-MF55 AM/FM radio, or the Suntone brand AM/FM headphone radio. Receiver 52 receives the high frequency signal, derives the second sound track, and audibly plays the second sound track, in the second language, for such film viewer, preferably through a pair of headphones. Should it be desired to transmit two or more sound tracks (in two or more different languages), then additional playback machines (identical to second playback machine 42) could be added, and two or more local FM transmitters could be used to broadcast such sound tracks on different carrier frequencies. Film viewers would then be instructed to tune their receivers (52) to the carrier frequency corresponding to the particular language they desire.

Thus, movie projection system 20 broadcasts the film sound track in at least two different languages simultaneously to first and second film viewers located in the same theater at the same time. While transmitter 48 is illustrated as a radio frequency transmission system, optical (infrared) transmitter/receiver components could be used instead. Alternatively, transmitter 48 could be replaced by a hard wired connection coupled between second playback machine 42 and a headphone jack (not shown) provided at each seat in the theater. Those viewers desiring to hear the second sound track then simply plug in headphones to listen to such second sound track. In the case where three or more different sound tracks are provided (i.e., one sound track over the theater speakers, and at least two different sound tracks for private listening), the headphone jack provided at each theater seat may include a selection knob, like those incorporated in airline seats, to select a desired language channel.

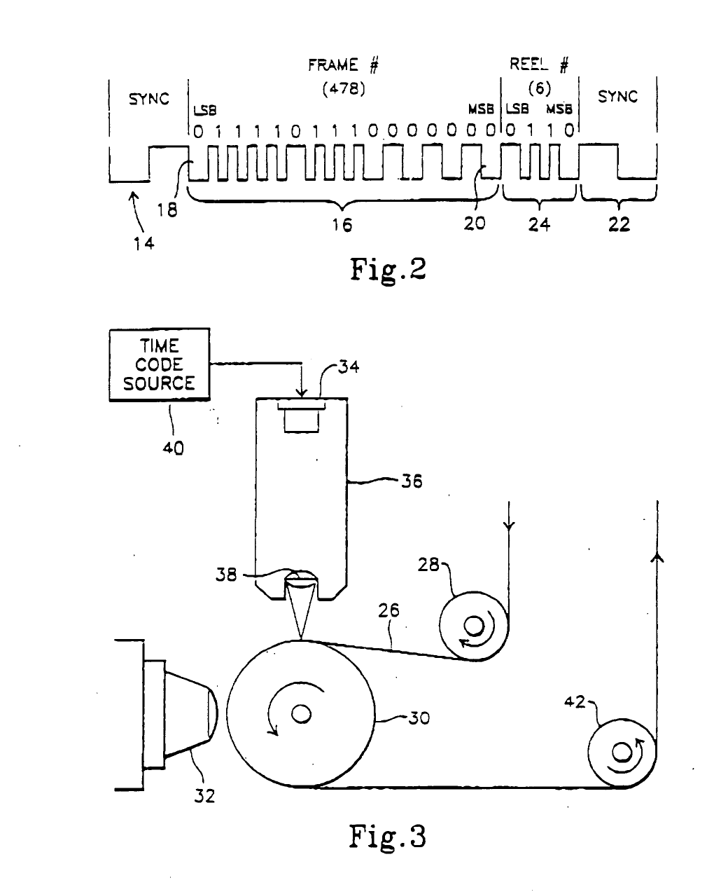

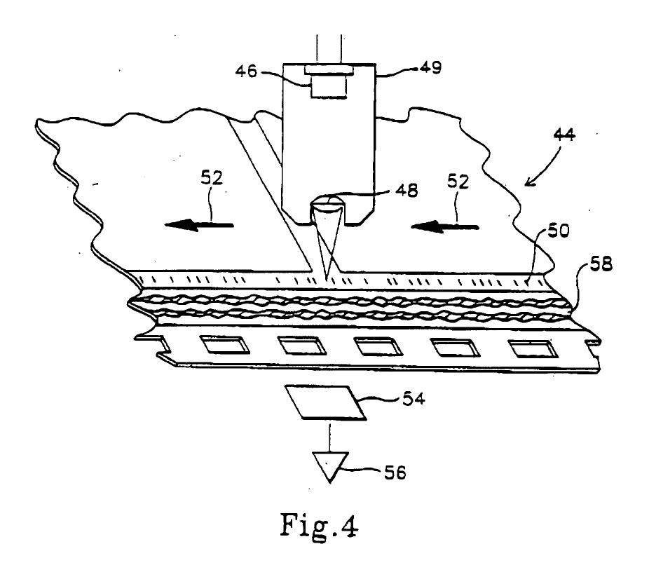

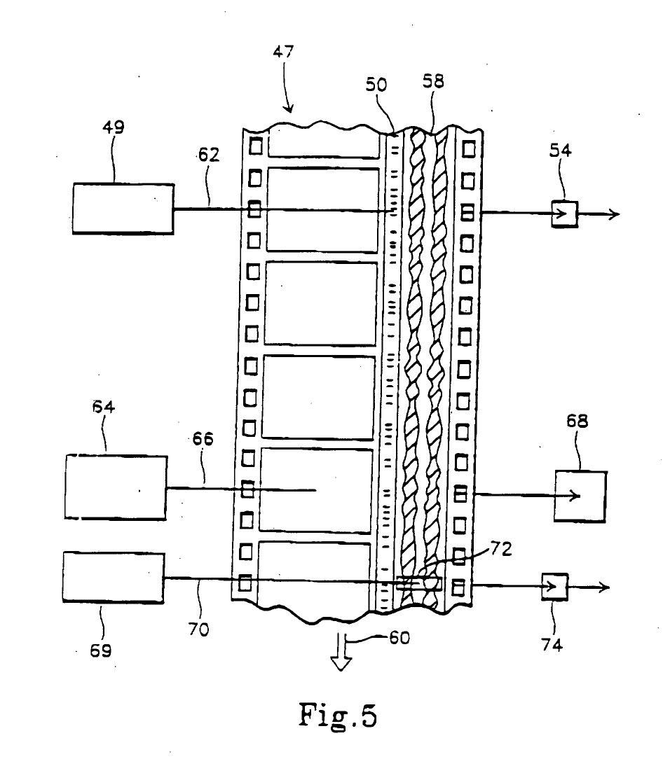

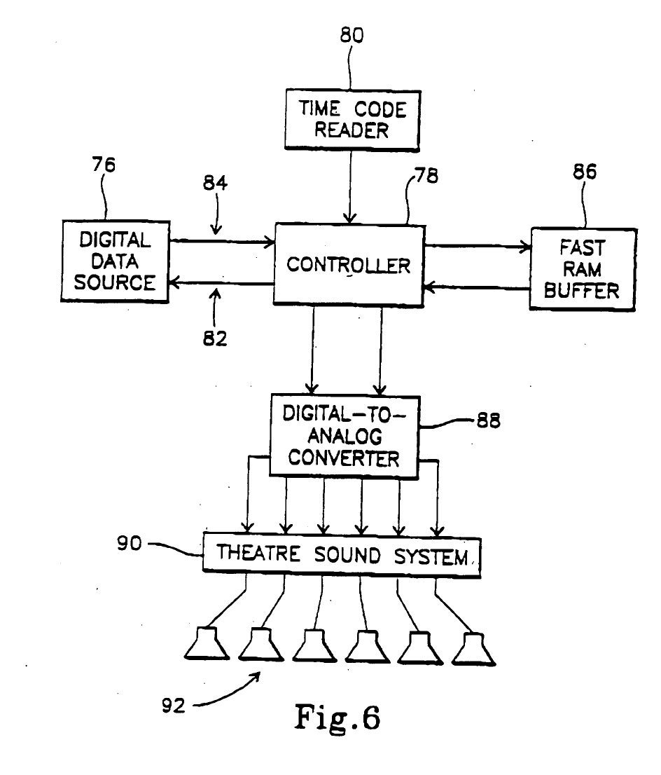

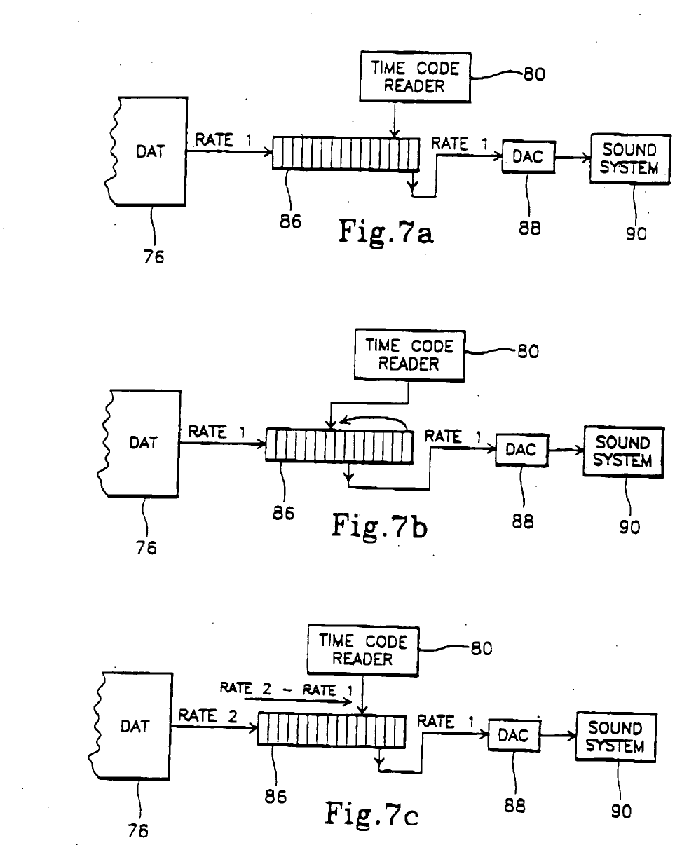

Turning to FIG. 2, the projection system shown therein is essentially identical to the projection system described above in regard to FIG. 1, except that the system of FIG. 2 directly couples second playback machine 42 to time code reader 24 in parallel with first playback machine 28. The system of FIG. 2 uses a split cable 56 from time code reader 24 leading directly to both first and second playback machines 28 and 42.

Another aspect of the present invention relates to a method of projecting moving images of a film and for broadcasting a film sound track in at least two different languages simultaneously to first and second film viewers located in the same location. Referring again to FIG. 1, the method includes the step of projecting images recorded on the film for simultaneous viewing by first and second film viewers, as by using projection unit 22. The method also includes the step of detecting the time code signals recorded on the film and deriving sync signals therefrom, as by using time code reader 24. The method further includes the steps of generating first and second sound tracks in first and second different languages, respectively, and synchronized with the images recorded on the film, e.g., in the manner performed by first and second playback machines 28 and 42. The first sound track is then transmitted to a first group of film viewers, as by using the theater speaker system (32, 38, 40), while transmitting the second sound track to a second group of film viewers, as by using the wireless transmitter/receiver system (48/52) illustrated in FIG. 1.

As described above, the new system makes use of the existing time code reader to activate first playback machine 28 to generate the first sound track in the first language, and uses the conventional sound processor 32, amplifier 38, and speakers 40 to play the first sound track. Moreover, the new system adds a second playback machine 42, responsive to the same time code from the film. However, second playback machine 42 has CD's containing the sound track in the second language. Second playback machine 42 has a separate transmitter (e.g., 48) to transmit the second language into the theater simultaneously with the first language of the standard speaker system, to allow both languages to be heard with one movie in the same room. People viewing the movie could either hear it in the first language (e.g., English) or could use a receiving device, such as a radio with headphones to receive the second language (e.g., Spanish). The second sound track (in the second language) can be transmitted with an AM or FM radio transmitter, or an infrared transmitter, and received by receivers in the form of standard AM/FM radios or infrared receivers. If desired, the transmission system for transmitting the second sound track could also be a closed system whereby the transmitter would only transmit to specific receivers that are only able to receive such transmission. Once again, transmitter 48 could be replaced by a hard wired connection coupled between second playback machine 42 and a headphone jack (not shown) provided at each seat in the theater.

Those skilled in the art will realize that the present invention is not limited to only two languages at a time, and that there could be numerous playback machines/transmission systems, all operating in synchronized fashion based upon the time code signals recorded on the film, to play numerous languages with a particular film. In such case, and assuming that the secondary sound track transmission system is effectively hard wired into the theater, as by providing each theater seat with built-in headphone jacks, the film user could operate a channel selector dial to select the channel having the sound track in the particular language desired.

While the preferred embodiment has been shown and described as including only a single time code reader for generating sync signals that are shared by the first and second playback machines, it may also be possible to interface a second time code reader on the film projection unit to separately derive sync signals to synchronize the second playback machine, if desired. In this manner, each playback machine would have its own time code signals generated by its own time code reader. Finally, while the preferred embodiment has been described as including first and second playback machines that are physically distinct from each other, another alternative approach would be to build one overall playback machine, or playback system, that could hold and play a larger number of CDs, or store and retrieve a larger number of digital sound files, than is true for currently available playback machines, and to provide multiple output ports to output multiple sound tracks in different languages simultaneously from a single overall playback machine. In this instance, one may regard such single overall playback machine, or playback system, as effectively combining together two or more playback machines of the type already described above. In this regard, the portion of the overall playback machine that plays and/or retrieves the first sound track could be regarded as the “first playback machine”, and the portion of the overall playback machine that plays and/or retrieves the second sound track could be regarded as the “second playback machine”.

In addition, while the preferred embodiment of the present invention uses playback machines to derive sound tracks in two or more languages simultaneously, it would also be possible to embed two or more soundtracks on the movie film itself, and to recover both sound tracks simultaneously as the film passes through the projection unit. The two sound tracks could then be amplified and separately transmitted to first and second groups of film viewers who speak different languages while they view the same movie.

Those skilled in the art will now appreciate that a movie projection system has been described which allows theater-goers who do not understand English well to attend movie theaters showing English-language films and still enjoy the movie. Moreover, the described movie projection system allows a number of different theater-goers within the same movie theater to simultaneously view the same movie images while hearing the movie sound track simultaneously in different languages. It will also be appreciated that the described movie projection system can be constructed as a combination of well-known, currently-available components at relatively little cost.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

1. A movie projection system for projecting moving images of a film and for broadcasting a film sound track in at least two different languages simultaneously to first and second film viewers located in the same location, the film having recorded thereon both images and time code signals for syncing a film sound track, said movie projection system comprising in combination:
a. a film projection unit for projecting images recorded on the film;
b. a time code reader coupled to said film projection unit for detecting the time code signals recorded on the film and deriving sync signals therefrom;
c. a first playback machine coupled to said time code reader for receiving the sync signals, the first playback machine generating a first sound track in a first language synchronized with the images recorded on the film;
d. a first transmission system coupled to said first playback machine for transmitting the first sound track to the first film viewer;
e. a second playback machine coupled to said time code reader and responsive to the sync signals, the second playback machine generating a second sound track in a second language synchronized with the images recorded on the film, the second language differing from the first language; and
f. a second transmission system coupled to said second playback machine for transmitting the second sound track to the second film viewer.

2. The movie projection system recited by claim 1 wherein the first transmission system includes a sound processor for decoding sound signals generated by said first playback machine.

3. The movie projection system recited by claim 2 wherein the first transmission system includes an amplifier for amplifying decoded sound signals provided by said sound processor.

4. The movie projection system recited by claim 3 including a plurality of speakers coupled to said amplifier for playing the first sound track audibly to the first film viewer at the location.

5. The movie projection system recited by claim 1 wherein the second transmission system includes:
a. a wireless transmitter for transmitting a high frequency signal within the location, the high frequency signal having a frequency above the range that is audible by humans and containing the second sound track;
b. a wireless receiver disposed proximate the second film viewer for receiving the high frequency signal, deriving the second sound track therefrom, and playing the second sound track audibly to the second film viewer at the location.

6. The movie projection system recited by claim 1 wherein the location is a movie theater.

7. The movie projection system recited by claim 1 wherein said second playback machine is coupled to said time code reader by said first playback machine.

8. The movie projection system recited by claim 1 wherein said first playback machine plays compact discs of the first language.

9. The movie projection system recited by claim 8 wherein said second playback machine plays compact discs of the second language.

10. The movie projection system recited by claim 1 wherein said second transmission system includes:
a. a hard wired connection coupled between said second playback machine and a signal port provided on a seat proximate the second film viewer; and
b. headphones worn by the second film viewer and coupled to said signal port for conveying the second sound track to the ears of the second film viewer.

11. A method of projecting moving images of a film and for broadcasting a film sound track in at least two different languages simultaneously to first and second film viewers located in the same location, the film having recorded thereon both images and time code signals for syncing a film sound track, the method comprising the steps of:
a. projecting images recorded on the film for simultaneous viewing by first and second film viewers;
b. detecting the time code signals recorded on the film and deriving sync signals therefrom;
c. generating a first sound track in a first language synchronized with the images recorded on the film;
d. transmitting the first sound track to the first film viewer;
e. generating a second sound track in a second language synchronized with the images recorded on the film, the second language differing from the first language; and
f. transmitting the second sound track to the second film viewer.

12. The method recited by claim 11 wherein the steps of generating the first and second sound tracks includes the steps of playing a first compact disc recorded in the first language, and playing a second compact disc recorded in the second language.

13. The method recited by claim 11 wherein the steps of generating the first and second sound tracks includes the steps of retrieving a first stored digital sound file containing the first sound track, and retrieving a second stored digital sound file containing the second sound track.

14. The method recited by claim 11 wherein the step of transmitting the first sound track to the first film viewer includes the steps of amplifying the first sound track and driving audio speakers installed at the location with the amplified first sound track.

15. The method recited by claim 11 wherein the step of transmitting the second sound track to the second film viewer includes the steps of:
a. transmitting a high frequency signal within the location, the high frequency signal having a frequency above the range that is audible by humans and containing the second sound track;
b. receiving the high frequency signal proximate the second film viewer, deriving the second sound track therefrom, and playing the second sound track audibly to the second film viewer at the location.

16. The method recited by claim 11 wherein the location at which said method is performed is a movie theater.

17. The method recited by claim 11 wherein the step of transmitting the second sound track to the second film viewer includes the steps of:
a. conveying the second sound track over a hard wired connection to a signal port provided on a seat proximate the second film viewer; and
b. connecting headphones to the signal port for conveying the second sound track to the ears of the second film viewer.

18. A movie projection system for projecting moving images of a film at a predetermined location and for broadcasting a film sound track in at least two different languages simultaneously to first and second film viewers located at such predetermined location, the film having recorded thereon both images and time code signals for syncing a film sound track, said movie projection system comprising in combination:
a. a film projection unit for projecting images recorded on the film;
b. a time code reader coupled to said film projection unit for detecting the time code signals recorded on the film and deriving sync signals therefrom;
c. a playback system coupled to said time code reader for receiving the sync signals, the playback system generating a first sound track in a first language synchronized with the images recorded on the film, said playback system also generating a second sound track in a second language synchronized with the images recorded on the film, the second language differing from the first language;
d. a first transmission system coupled to said playback system for transmitting the first sound track to the first film viewer; and
e. a second transmission system coupled to said playback system for transmitting the second sound track to the second film viewer.

19. The movie projection system recited by claim 18 wherein the playback system includes a first playback machine responsive to said time code reader for generating the first sound track, and wherein the playback system includes a second playback machine responsive to said time code reader for generating the second sound track.

20. The movie projection system recited by claim 18 wherein the movie projection system includes a sound processor for decoding sound signals generated by the playback system.

21. The movie projection system recited by claim 20 wherein the first transmission system includes an amplifier for amplifying decoded sound signals provided by said sound processor.

22. The movie projection system recited by claim 21 including a plurality of speakers coupled to said amplifier for playing the first sound track audibly to the first film viewer at the location.

23. The movie projection system recited by claim 18 wherein the second transmission system includes:
a. a wireless transmitter for transmitting a high frequency signal within the predetermined location, the high frequency signal having a frequency above the range that is audible by humans and containing the second sound track;
b. a wireless receiver disposed proximate the second film viewer for receiving the high frequency signal, deriving the second sound track therefrom, and playing the second sound track audibly to the second film viewer at the predetermined location.

24. The movie projection system recited by claim 18 wherein the predetermined location is a movie theater.

25. The movie projection system recited by claim 19 wherein said second playback machine is coupled to said time code reader by said first playback machine.

26. The movie projection system recited by claim 18 wherein said playback system plays compact discs containing the first and second sound tracks.

27. The movie projection system recited by claim 18 wherein said playback system retrieves stored digital files to generate the first and second sound tracks.

28. The movie projection system recited by claim 18 wherein said second transmission system includes:
a. a hard wired connection coupled between said playback system a headphone port provided at a seat proximate the second film viewer; and
b. headphones worn by the second film viewer and coupled to said headphone port for conveying the second sound track to the ears of the second film viewer.

29. The movie projection system recited by claim 11 wherein:
a. said playback system also generates a third sound track in a third language synchronized with the images recorded on the film, the third language differing from the first and second languages; and
b. a selector control provided at the seat proximate the second film viewer for selecting either the second sound track or the third sound track to be conveyed to the ears of the second film viewer.
